(19) United States
(12) Patent Application Publication
(10) Pub. No.: US 2007/0102344 A1
(43) Pub. Date: May 10, 2007

(54) Separating device, holding device and method for separation

(76) Inventor: Franz Konrad, Oberndorf bei Schwanenstadt (AT)

Correspondence Address: WILLIAM COLLARD;COLLARD & ROE, P.C., 1077 NORTHERN BOULEVARD, ROSLYN, NY, 11576, US

(21) Appl. No.: 11/542,096

(22) Filed: Oct. 3, 2006

(30) Foreign Application Priority Data
Oct. 4, 2005 (AT) A 1618/2005

(51) Int. Cl. B01D 35/00

(52) U.S. Cl. 210/455

(57) ABSTRACT

The invention describes a separation device (11) for insertion into an interior space (10) of a holding container (5) of a holding device (1) for the components of substances to be separated such as body fluids, tissue parts and/or tissue cultures, whereby the separation device (11) comprises at least one separation element (42) with end faces (44, 45) set a distance apart from one another in the direction of the longitudinal axis (15) and several channels (56) extending between the two end faces (44, 45) are arranged in the separation element (42). The channels (46) arranged in the separation element (42) are designed so that in a working position they allow the components of the substance to be separated to pass through exclusively while a compressive force is being applied to the substance, and in a separation position, the channels (46) suppress the passage of the components that are to be separated. In addition the invention also relates to a holding device (1) equipped with this separation device (11) and a method for separation of components to be separated.

### BACKGROUND OF THE INVENTION

1. Field of the Invention

The invention relates to a separation device for use in the interior space of a holding container, a holding device equipped therewith and a method for separating components of a substance such as a body fluid, tissue parts and/or tissue cultures, as described in claims 1, 28 and 52.

2. Prior Art

Various methods and equipment for treatment are already known. Substances such as blood are divided into a light phase and a heavy phase. The light phase in the case of blood is formed by blood serum and/or blood plasma, for example, whereas the heavy portion of blood is formed by cellular components such as blood cells.

The plunger movable in the interior space of the blood test tube under the influence of centrifugal force, especially in centrifugation of the sample, is usually designed so that it is deformed under the influence of centrifugal force and permits passage of the lightweight components upward in the direction of the open end of the tube, which at this point in time, is usually closed with a closing device, whereas the movable plunger comes to rest on the heavy phase of the blood, i.e., the blood cells, and therefore can no longer pass downward through them in the direction of the closed end of the tube. This achieves accurate separation of blood cells from blood plasma and blood serum.

Blood serum is extremely important in medicine because various essential ingredients such as glucose, cholesterol, calcium, inorganic phosphorus, proteins, uric acid and other substances can be determined by such analyses of blood serum and/or blood plasma. This analytical data directly correlates with the health of the person tested by taking the blood sample.

Such blood test tubes equipped with a movable plunger and/or methods using such a movable plunger are already known from U.S. Pat. No. 3,508,653 A, U.S. Pat. No. 4,294,707 A and U.S. Pat. No. 6,280,400 B1.

U.S. Pat. No. 6,280,400 B1 discloses a separation body designed as an elongated shape having an elastic top part and an elongated bottom part with an opening passing through the latter. The elastic top part is held on the inside wall of the holding container with a press fit, whereby passage of one of the media to be separated either between the top part and the inside wall or through a through-slot arranged in the top part is accomplished during the centrifugation process. Satisfactory separation could not be prevented in all cases.

Another separation device for use in a holding space of a holding container of a holding device is described in U.S. Pat. No. 5,266,199 A, which discloses an elastic carrying body, an elastic ring surrounding the latter, having a separation in its circumferential area, and a ball insertable into a flow channel within the elastic carrying body to provide a seal. The elastic ring surrounding the elastic carrying body serves as a closing device between the inside wall of the holding container and the elastic carrying body in the separation position of the separation device. The flow channel arranged in the elastic carrying body, extending between the end areas that are spaced a distance apart in the direction of the longitudinal axis is closed in the dividing position by the ball floating on the denser components.

EP 0 753 741 A1 describes a holding device having a holding container which has two ends spaced a distance apart in the longitudinal axis, at least one of them being designed with an opening. The inside dimension of the holding container in the area of the first open end in the plane perpendicular to the longitudinal axis is greater than the inside dimension in the area of the other end of the plane parallel thereto and the same direction in space. In addition, a ring-shaped component is inserted into the open end, covering the open end face of the holding container with a collar, and a cylindrical wall part protrudes in at least some areas into the interior space of the holding container. The ring-shaped component has a shoulder connected to the cylindrical wall part and further connected there to a cross-sectional enlargement on which is supported the elastic sealing element of the separation device in the starting position. At the center, the separation device has a recess which is closed with a thin cover plate in the area of the upper end of the holding container. The joining of the individual components, in particular the insertion of the separation device, is performed in a vacuum chamber because after inserting the separation device, access to the interior is no longer possible without damaging the separation device. In addition, a film is also glued to the collar-shaped shoulder of the ring-shaped component and a cap is also applied. The interior space is filled by puncturing through the thin cover plate of the separating device, the thin film and optionally the cap. Through this filling procedure, the vacuum in the interior is dissipated, so that air is also drawn into the interior. This is followed by the centrifugation process in which the separation device comes out of the ring-shaped component in the direction of the sealed end and comes to rest with its sealing element on the inside surface of the holding container. The rate of sedimentation in the mixture and/or the components already separated is determined by the pressing force of the elastic sealing element on the inside surface. Through the choice of the specific gravity of the entire separation device with respect to the components of the mixture to be separated, the components are floated at the separation interface between the media which have a difference in specific gravity. The lighter medium can pass between the inside surface of the holding container and the elastic sealing element during the centrifugation process.

EP 1 005 910 A2 discloses another holding device with a separation device, which has a cylindrical holding container with an almost constant inside diameter. A puncturable closing device is provided on the open end of the holding container; even in the starting position, the separation device is arranged virtually in contact with said puncturable closing device. This separation device is formed by a flexible memory material, a sealing device for sealing with the inside surface of the holding container being provided on the outside circumference of the separation device. In addition, a deformable element is also inserted into the interior, pressing with the pressure exerted by the medium on the inside wall of the outer container while the centrifugal force is acting, thereby forming a flow-through channel between the separation device and the inserted deformed insertion part, so that after the application of centrifugal force stops, this flow-through channel again assumes a sealing position with the sealing elements arranged on the separating device, thereby keeping the media separate after they have been separated from one another.

Another separation device and/or holding device with a separation device and a corresponding method are known from DE 195 13 453 A1, which discloses a holding container that resembles a test tube and is closed in an open end face area with a closing device and into which a separation device for separating the different media of the mixture after separation is inserted. To prevent the end face of the separation device, which only comes in contact with the medium subsequently, from being contaminated when adding the mixture to the interior space of the container, the separation device is provided with a through-opening in the central area through which the mixture can be introduced into the remaining interior space of the holding container. During the following separation process, the medium separated from the mixture is transferred through the passage in the separation device to the area between the closing device and the separation process by centrifugation in the traditional manner with a radial centrifugal force (rcf) of 1000 g to 5000 g, where g denotes gravitational force and 1 g has a value of 9.81 m/s², and the medium sinks as a result of this in the direction of the closed end of the holding container. To prevent the other medium which is between the closed end and the separation device from being able to mix again with the medium already separated from it after the separation is accomplished through the perforation between the closed end and the separation device, an end stop that widens in a conical shape in the direction of the closed end is provided at a height corresponding to the usual remaining amount of the other medium; with this end stop, the separation device runs up against the end stop protruding through the perforation. As soon as the outside diameter of the end stop corresponds to the inside diameter of the perforation, the separation device remains in this position and therefore the perforation is closed by the stop and there can be no exchange of the two media and no repeated mixing of the two media. One disadvantage of this variant is that a special tube with a stop on the inside must be manufactured, and reliable medium separation through the perforation situated in the separation device cannot be ensured. In addition, a permanent tight seal between the two separate phases is not always possible.

Other holding devices for centrifugation of mixtures of at least two different media to be separated in which the holding container is closed with a closing device into end face areas are known from WO 96/05770 A1. A separation device formed by a sealing disk in the form of a gel is provided in the interior. Because of the centrifugal forces acting on the medium during the centrifugation process, this gel plunger migrates between the two different media that are separated from one another because of its specific gravity, which is higher than the specific gravity of the medium having the lower specific gravity and lower than the specific gravity of the medium having the higher specific gravity. In the resulting position, there cannot be any separation of one medium from the other medium of the mixture. The disadvantage here is that in many cases the duration of storage is not sufficient for a normal use time due to the fact that the separation device is made of a gel.

Other holding devices having separation devices for separation of mixtures during centrifugation are known from U.S. Pat. No. 3,931,018 A, U.S. Pat. No. 3,779,383 A, U.S. Pat. No. 3,849,072 A, U.S. Pat. No. 3,862,042 A, U.S. Pat. No. 3,882,021 A, U.S. Pat. No. 3,887,464 A, U.S. Pat. No. 3,887,465 A, U.S. Pat. No. 3,890,237 A, U.S. Pat. No. 3,891,553 A, U.S. Pat. No. 3,894,950 A, U.S. Pat. No. 3,894,951 A, U.S. Pat. No. 3,897,337 A, U.S. Pat. No. 3,897,340 A, U.S. Pat. No. 3,897,343 A, U.S. Pat. No. 3,931,010 A, U.S. Pat. No. 3,931,018, U.S. Pat. No. 5,632,895 A1, U.S. Pat. No. 5,860,937 A, U.S. Pat. No. 6,406,671 B1, U.S. Pat. No. 6,516,953 B1, EP 0 753 741 A1, EP 1 006 360 A2, EP 1 106 250 A2, EP 1 106 251 A2, EP 1 106 252 A2, EP 1 106 253 A2, DE 2 243 569 A.

### OBJECTS AND ADVANTAGES OF THE INVENTION

The object of the present invention is to create a separation device, a holding device equipped with such a separation device and a method for separation which allows reliable functioning and a high degree of purity following separation, which are achieved with a simple design.

The object of this invention is achieved by the features of claim 1. The surprising advantage obtained through the features of the characterizing part of claim 1 is that the channels provided in the separation element are designed so that all the components of the substance to be separated can pass through the column of liquid only by applying a compressive force and/or a pressure difference to the column of fluid to be separated. The compressive forces can be built up through centrifugal forces but also through pressure differences on the two sides of the end faces. When these compressive forces are removed, the channels prevent any passage of the components to be separated so that after successful separation as is the case when extracting serum and/or plasma, a permanent separation of the components that have been separated from one another by physical means, is maintained. This prevents subsequent mixing and yields a high level of purity. This passage permits a simple design of the separation element from a structural standpoint and can also be manufactured inexpensively.

Another embodiment according to claim 2 is also advantageous because this permits confirmed passage of the heavy components as is the case with blood. At the same time, however, a lighter medium that has already passed through can flow back through the separation device into the partial space provided for it.

In addition, a design according to claim 3 is also advantageous because this suppresses premature passage of the components to be separated prior to application of the required minimum compressive force.

Due to the design according to claim 4, it is possible to achieve even more reliable separation between the two components that are to be separated from one another.

According to another design variant according to claim 5 or 6, in the area of the channels a type of valve effect is achieved, whereby the opening and closing are accomplished as a function of the compressive force acting on the separation element and/or the channels, which also makes it possible to achieve a high level of security for the user.

A refinement according to claim 7 is also advantageous because in this way, different applications can easily be taken into account and therefore the size of the components passing through can be defined more easily.

In the embodiment according to claim 8, it is advantageous that when the separation device has already been used, the entire interior can be evacuated prior to being closed with the closing device.

With the refinement according to claim 9, a secure seal can also be achieved in the area of the outside circumference.

With a design according to claim 10 or 11, an adaptation to different internal dimensions of the holding container is readily possible with the same dimensions of the separation element.

A design according to claim 12 is also advantageous because in this way, an-adequate sealing effect can also be achieved in the area of the carrying body between the carrying body and the inside surface of the holding container.

According to one embodiment as described in claims 13 through 15, a uniform one-piece structural unit composed of several components may be created, each component being designed to be easy to handle and with coordinated functionality.

A design according to claim 16 has proven advantageous because this permits an even greater reliability in the area of the connection point with regard to the strength and imperviousness of the seal.

In another advantageous embodiment according to claim 17 or 18, an additional holder is created between the two complements to be joined, thereby forming a holder that is reliable in operation.

However, an embodiment according to claim 19 is also advantageous because in this way, unintentional retention of heavy components in the area of the separation space provided for the plasma and/or serum is prevented.

According to claims 20 through 22, the separation element can easily be adapted to a wide variety of use conditions. Furthermore, possible interactions between the materials of the separation element and the components of the substance to be separated can also be ruled out and/or taken into account.

In the embodiment according to claim 23, interactions between the separation element to be accommodated and/or the holding container can easily be taken into account and also adapted to a wide variety of use conditions.

Designs according to claims 24 through 27 are also possible because in this way, the sticking of components of the substance to be separated can be prevented and/or flow of the components of the substance through the channels while applying the compressive force is facilitated and/or promoted. This makes it possible to achieve even higher degrees of purity of the components to be separated, in particular the serum and/or plasma.

However, the object of the invention is independently solved by the features of claim 28. The advantages derived from the combination of features of the characterizing part of this claim lie in the fact that the separation device is held in a predetermined position in a stationary position in relation to the holding container even before filling the interior with the components to be separated. Due to this stationary mounting, this avoids additional leakage problems with respect to the separation equipment known in the past with which the separation has always been shifted in the direction of its longitudinal axis following the separation process owing to the centrifugal force acting on the separation device in relation to the holding container. Operational reliability is achieved here because the preselectable position can be defined exactly and thus a satisfactory separation result between the components of the substance that are to be separated can be achieved reliably. In addition, precisely predetermined partial spaces are created in the interior space of the holding container by the stationary holder, each serving to hold the components to be separated. In addition, the design of the entire separation device is greatly facilitated because there is no longer any relative movement between the separation device and the holding container. This creates a compact design unit that is reliable in operation, easy and inexpensive to manufacture and also offers a high operational reliability during use and in particular during use as intended.

Another embodiment according to claim 29 is also advantageous because this provided the holding volume that is absolutely necessary to achieve satisfactory separation without any mixing and/or residues in the lighter of the components to be separated such as serum and/or plasma.

Another embodiment according to claim 30 is also advantageous because in this way, the separation device is held in a stationary position with regard to the holding container in both directions of movement so that a subsequent release and/or displacement is reliably prevented.

Due to the embodiments according to claims 31 through 33, it is possible to take into account a wide variety of material combinations and use conditions and nevertheless achieve a secure holding of the separation device with respect to the holding container.

According to other variants of embodiments according to claims 34 through 43, a part that is simple to manufacture and install is created and can be inserted into the interior space of the holding container. This makes it possible to use holding containers designed according to the standard where the partial length of the inside housing is to be coordinated as a function of the filling volume to be held and thus a wide variety of use conditions can be taken into account quickly. In addition, by arranging and/or designing at one flow channel between the inside surface of the holding container and the outside surface of the inside housing, insertion of the inside housing into the holding container is facilitated while at the same time inclusion of an air volume between these two components is reliably prevented.

At the same time, however, the residual air that is still present can also be removed from these areas by suction in the wake of the evacuation of the interior.

Refinements according to claims 44 through 46 are also advantageous because a satisfactory welded joint between the components that are to be joined together can therefore be taken into account with regard to the imperviousness as well as with regard to the quality of the joint and therefore the strength of the joint.

In the embodiment according to claim 47 or 48, it is advantageous that a wide variety of use conditions can thus easily be taken into account and an interaction between the materials used and the components of the substance with regard to the substances to be separated can be avoided and/or prevented.

Through the further embodiment according to claim 49, this achieves the result that the material used is one which has neutral properties with regard to the components to be separated, and furthermore, any combination with the plastic material is possible.

Due to the design according to claim 50, the amount of the mixture to be accommodated and/or the amount of substance to be accommodated can be defined easily based on the extent of the vacuum in the interior space of the holding container and in addition the filling operation can be accelerated and/or facilitated.

An embodiment according to claim 51 is also advantageous, because depending on the type of coating, in particular the chemicals used, an influence and/or pretreatment of the substance and/or its components is made possible to therefore achieve satisfactory analytical results.

However, independently thereof, the object of the invention is also achieved by a method for separating components of substances according to the features characterized in claim 52. The advantages deriving from the combination of features of this claim include the fact that the manufacturing and production of the holding device and the separation device arranged therein are greatly simplified in this way because any relative movements between the separation device and the holding device can be prevented by the predetermined position and the stationary mounting during the separation operation. Therefore, a mounting device is made available which is easy to operate during the filling operation and has a high operational reliability in achieving purity during the centrifugation operation. In addition, it is advantageous here that passage of the individual components of the substance to be separated is made possible only on exceeding a predetermined minimum force in both directions of passage and in all other operating states a reliable seal is created by the separation element between the two partial spaces.

In addition, a procedure according to the features characterized in claim 53 is also advantageous because the amount of mixture to be accommodated in the holding container can be defined by the extent of the preselectable vacuum.

Another advantageous procedure is described in claim 54 so that after successful separation, a subsequent mixing in both directions of passage is reliably prevented.

A process variant according to claim 55 is also advantageous because then a premature passage is prevented before the start of the separation process and/or in application of the compressive force and thus the entire substance held therein can subsequently be exposed to the applied compressive force for the separation process subsequently.

In addition, a procedure according to the features characterized in claim 56 or 57 is advantageous because in this way, the channels permit or suppress passage in the form of a valve action as a function of the compressive force acting on the substance, in particular the centrifugal force. In this way, a satisfactory separation result can be achieved with a high degree of purity.

Finally, another advantageous procedure is described in claim 58 so that, depending on the chemicals applied, an influence on and/or an effect on the substance added and/or its components is made possible so that the subsequent analytical processes can be performed satisfactorily.

### BRIEF DESCRIPTION OF THE DRAWINGS

The present invention is explained in greater detail below on the basis of the exemplary embodiments depicted in the drawings. Of these:

FIG. 1 shows a holding device designed according to this invention with a separation device arranged in the starting position and a closing device and a filled interior space, shown in a sectional side view and in a simplified schematic diagram;

FIG. 2 shows a part of another holding device with another inventive separation device arranged in the starting position, shown in a sectional side view and in a simplified schematic diagram;

FIG. 3 shows a part of another holding device with a separation device arranged in the starting position, shown in a sectional side view and in a simplified schematic diagram;

FIG. 4 shows a possible embodiment of the separation device, shown in a sectional side view and a simplified schematic diagram;

FIG. 5 shows a part of another holding device with a separation device arranged in the starting position, shown in a sectional side view and a simplified schematic diagram.

### DETAILED DESCRIPTION OF PREFERRED EMBODIMENTS

By way of introduction, it should be pointed out that the same parts in the different embodiments described here are labeled with the same reference numerals and/or the same component designations, whereby the disclosure contained in the entire description can be applied appropriately to the same parts with the same reference numerals and/or the same component designations. The position information (e.g., above, below, at the side, etc.) selected in the description is based on the figure being presented and described directly and can be scaled up appropriately to the new position when there is a change in position. In addition, individual features or combinations of features from the various exemplary embodiments illustrated and described here may constitute independent or inventive embodiments or may be used according to the invention.

The exemplary embodiments show possible design variants of the separation device and/or a holding device, and it should be pointed out here that the invention is not limited to the specific embodiments depicted therein but instead various combinations of the individual design variants among one another are possible and these possible variations are within the abilities of those skilled in the art active in this technical field on the basis of the teaching for technical action by the present invention. Thus, all conceivable variants of embodiments that are possible by combining individual details of the design variant presented and described here are also included by the scope of protection.

All information on value ranges in the present description is to be understood as meaning that any and all partial ranges therefrom are also included; for example, the notation 1 through 10 is to be understood as meaning that all partial areas starting from the lower limit 1 to the upper limit 10 are also included, i.e., all partial areas again with a lower limit of 1 or greater and end at an upper limit of 10 or less, e.g., 1 to 1.7 or 3.2 to 8.1 or 5.5 to 10.

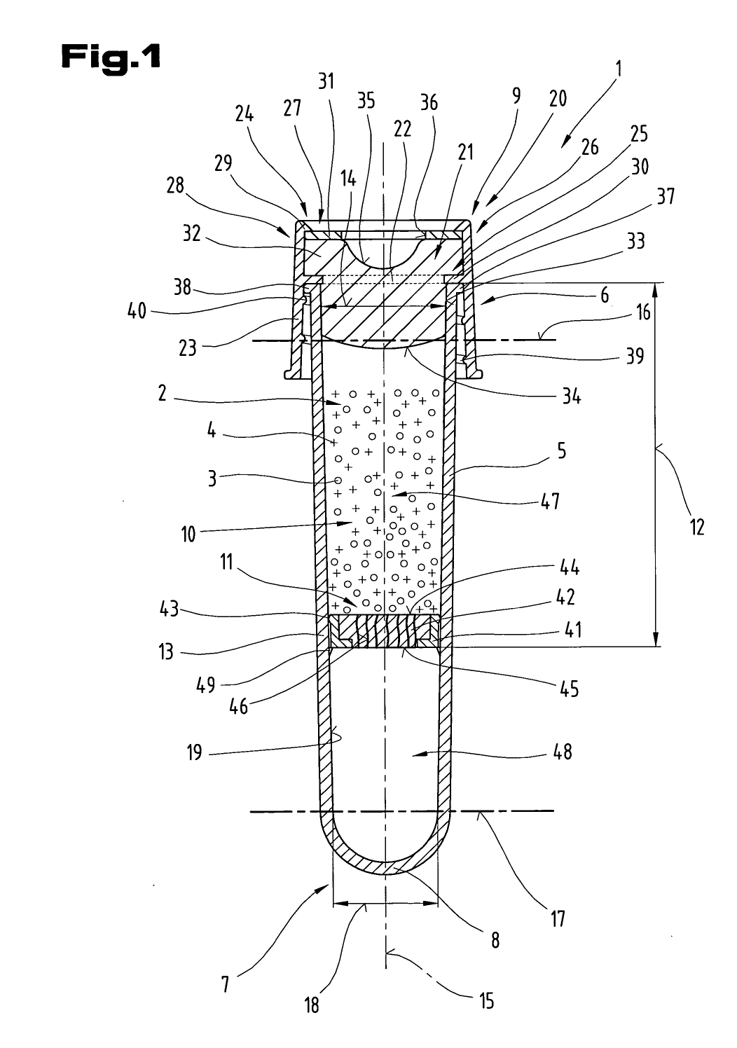

FIG. 1 shows a holding device 1 for a mixture 2 and/or substances consisting of at least two components and/or media 3, 4 that are different from one another such as body fluids, tissue parts and/or tissue cultures, which is designed so that the mixture 2 in the holding device 1 can be separated into at least two of its components. These components and/or media 3, 4 are serum and/or plasma in the case of blood, for example, as well as cellular components (erythrocytes, leukocytes and platelets). The erythrocytes are 7.5×2 μm in size and are anuclear cells shaped like a disk. A reversible change in shape is possible with these components.

The leukocytes include the granulocytes, monocytes and lymphocytes. The granulocytes have a segmented or rod-shaped cell nucleus. Neutrophils have a diameter between 9 μm and 12 μm, eosinophils have a diameter 11 μm and 14 μm and basophils have a diameter between 14 μm and 16 μm. Monocytes have a kidney-shaped cell nucleus with a size between 15 μm and 30 μm. Lymphocytes, however, have a round nucleus, the diameter of which may be between 7 μm and 9 μm or even 12 μm. The platelets have a disk shape with a size of 4 μm×0.6 μm and they have no nucleus.

This separation of the mixture 2 into its components and/or media 3, 4 may be accomplished physically, for example, by centrifugation in a traditional manner and starting from the resting position until achieving a radial centrifugal acceleration of 1000 g to 5000 g, preferably between 1800 g and 2200 g, where g denotes the acceleration due to gravity and the value of 1 g is 9.81 m/s². It is therefore possible, for example, to separate the phase that is more solid from the liquid phase and/or to separate the phases according to the different specific gravity values, as described in greater detail in the following figures for different embodiments.

The holding device 1 consists of a holding container 5 that is designed to be approximately cylindrical with two ends 6, 7 spaced a distance apart, whereby in this exemplary embodiment, the end 6 is designed to be open and the end 7 is designed to be closed by an end wall 8. The open end 6 here can be closed as needed with a closing device 9, which is a simplified diagram, and may be designed according to EP 0 445 707 B1, EP 0 419 490 B1, U.S. Pat. No. 5,275,299 A, U.S. Pat. No. 5,495,958 A and U.S. Pat. No. 5,522,518 A, whereby, to avoid repetition, reference is made to the disclosure for the design of the cap, the closing device, the housing and/or holding container, the coupling device between the cap and the closing device and the cap and the holding container 5 and the holding ring and this disclosure is included in the present patent application. A separation device 11 is inserted into an interior 10 surrounded by the holding container 5; said separation device is inserted into the holding container in the starting position even before filling the interior 10 with the components to be separated; in this position it is fixed at a predetermined distance 12 with regard to the holding container 5 starting from the open end 6 of the holding container 5 which is provided for filling and measured in the direction of the other end 7.

The procedure for assembling the individual components is described in greater detail below. This holding container 5 with the closing device 9 may be designed and/or used in a wide variety of embodiments, e.g., including being used as an evacuated blood test tube.

The holding container 5 may be designed as a bottle, vial or flask shape or the like and may be made of a wide variety of materials, e.g., plastic and/or glass. If plastic is chosen as the material for the holding container 5, it may be fluid-tight, in particular watertight and optionally airtight and may be made of, for example, polyethylene terephthalate (PET), polypropylene (PP), polyethylene (PE), polystyrene (PS), high-density polyethylene (HDPE), acrylonitrile-butadiene-styrene copolymer (ABS) or the like and/or a combination thereof. In addition, the holding container 5 has a container wall 13 with a wall thickness that preferably remains uniform, whereby the container wall 13 may extend starting from the one end 6 with an inside dimension 14 in a plane 16 aligned perpendicular to a longitudinal axis 15 running between the two ends 6, 7 to another plane 17 parallel to the first plane 16 and arranged in the area of the end 7 with a preferably smaller dimension 18. The container wall 13 of the holding container 5 has an inside surface 19 bordering the interior space 10 and an inner surface facing the interior space 10 as well as an outer surface facing away from the former, thus defining an outside circumference for the holding container 5. Thus an inner cross section which may have a wide variety of cross-sectional shapes, e.g., circular, ellipsoidal, oval, polygonal, etc. is defined on the basis of the inside surface 19 of the container wall 13 with the inside dimension 14, 18. The shape of the outer cross section may also be circular, ellipsoidal, oval, polygonal, etc., but it is also possible to design the shape of the outer cross section to be different from the shape of the inner cross section.

It is advantageous if the inside dimension 14 of the holding container 5 is designed to decrease steadily but minimally toward the inside dimension 18 starting from one end 6 and proceeding to the other end 7 at a distance from the former so that, for example, the holding container 5 can easily be unmolded from the injection die mold if the container is made of a plastic material in an injection molding process. In addition, due to this conical taper between the two planes 16, 17, the extent of the reduction in the inside dimension is predetermined here starting, from the large dimension 14 to the smaller dimension 18. The taper, i.e., the conical angle amounts to between 0.1° and 3.0°, preferably between 0.6° and 0.8° based on the opposing inside surfaces 19 of the holding container 5. Regardless of this, however, it is also possible to design the inside surface 19 and/or the outside surface of the holding container 5 to be parallel and/or cylindrical with regard to the longitudinal axis 15 in at least some areas. This may pertain to the section of the holding container 5 into which the separation device 11 is introduced up to the predetermined position.

At this point it should be mentioned that the dimensions described here are based the distance between the opposing inside and outside surfaces of the components, the diameter, the circumference along an enveloping end and/or an enveloping line as well as the cross section and/or cross-sectional area each in one of the planes 16, 17 aligned perpendicular to the longitudinal axis 15 and always the same spatial direction for determining the dimensions.

As this discussion also shows, the end 6 has an open end face which can be closed by the closing device 9, which can be opened as needed. Therefore the closing device 9 consists of a cap 20 that encompasses the open end face and a sealing device 21 held therein, e.g., a sealing stopper 22 made of a puncturable, highly elastic self-sealing material such as pharmaceutical-grade rubber, silicone rubber or bromobutyl rubber. This cap 20 is arranged concentrically with the longitudinal axial 15 and is formed by a ring-shaped and/or approximately tubular cap jacket 23. Between the cap 20 and the sealing device 21, means are provided for coupling, e.g., coupling parts 24 through 27 of a coupling device 28 consisting in the case of the cap 20 of protrusions 29, 30 arranged at least over some areas of the inside circumference, optionally a holding ring 31 and in the case of the sealing device 21 consisting of a shoulder 32 protruding over its outside circumference in at least some areas.

The sealing device 21 in the present exemplary embodiment is formed by the sealing stopper 22 and has a peripheral cylindrical sealing surface 33 which is arranged approximately concentrically with the longitudinal axis 15 and comes to rest on the inside surface of the holding container 5 in its sealing position in the section of the end 6. Therefore, in this section the inside surface and/or the inner face 19 of the holding container 5 is to be designed as a sealing surface in terms of its surface quality. In addition, the sealing device 21 also has another sealing face 34 which is aligned approximately perpendicularly with the longitudinal axis 15 and which closes and/or seals the interior space 10 of the holding container 5 on its open end face with respect to the outer environment in cooperation with the sealing face 33 that is in contact with the inside surface 19. Due to the arrangement of the protrusion 30 between the shoulder 32 protruding beyond the sealing face 33 and the open end face of the holding container 5, sticking and/or a great adhesion of the shoulder 32 directly on the end face can be prevented.

In addition, the sealing device 21 may also preferably have a recess on the side facing the holding ring 31, said recess having the same cross-sectional area as the opening 36 in the holding ring 31, whereby this opening 36 is designed with regard to its dimensions so as to permit unhindered flow-through a cannula (not shown here) and then puncture through the sealing device 21.

The shoulder 32 which forms the coupling part 26 and protrudes beyond the sealing face 33 of the sealing device 21 like a flange in at least partial areas of the circumference is held between the protrusions 29 and 30, which are arranged in two planes spaced a distance apart from one another in the direction of the longitudinal axis 15 and aligned perpendicular thereto and are designed, for example, as protrusions and/or locking protrusions running around the circumference in the form of a ring and/or in at least some areas. For secure holding of the sealing device 21 in the cap 20, it is also additionally possible to use the holding ring 31 between the shoulder 32 and the protrusion 29. The holding ring 31 here has a larger outside diameter than the inside dimension formed between the protrusions 29 and/or 30 in the direction perpendicular to the longitudinal axis 15. At the same time, the diameter of the opening 36 of the holding ring 31 is smaller than the largest outside dimension of the shoulder 32 in a plane perpendicular to the longitudinal axis 15. However, this outside dimension of the sealing device 21 is such that it is greater by at least twice the wall thickness of the holding container 5 than is the inside dimension 14 of the inside cross section and thus the interior space 10. Since the protrusion 30 that forms the coupling part 25 has an inside opening width which corresponds essentially to the inside dimension 14 of the holding container 5 in its upper end 6, the shoulder 32 is held very well in the cap 20 and is closed well between the interior space 10 of the holding container 5 and the atmosphere surrounding the holding device 1.

The imperviousness of the closing device 9 for the open end face of the holding device 1 is further improvement in particular if an outside diameter of the sealing device 21 is larger in the area of its sealing face 33 in the relaxed state outside of the holding container 5 than the inside dimension 14 of the holding container 5 in the area facing the sealing device 21.

In addition, in the relaxed uninstalled state, the longitudinal and/or height extent of the shoulder 32 of the sealing device 21 is greater in the direction of the longitudinal axis 15 than the distance of a groove-shaped recess between the two protrusions 29, 30 and optionally minus the thickness of the holding ring 31. Due to the differences in dimension between the groove-shaped recess and the longitudinal dimensions of the shoulder 32 and/or the thickness of the holding ring 31 in the direction of the longitudinal axis 15 as described above, there is an initial stress on the shoulder 32 between the two protrusions 29, 30. At the same time, this causes a compaction and prestress on the sealing device 21 with respect to the cap 20 and optionally additionally causes a tight seating of the holding ring 31 and full contact of the two end faces of the shoulder 32 in the area of the two protrusions 29, 30.

It is also advantageous if the cap material 23 is designed as a truncated cylindrical jacket and/or a truncated conical jacket so that overreach of the cap jacket 23 in the area of the upper end face of the holding container 5 is ensured.

In addition, it may prove advantageous if at least two guide protrusions 37, 38 are arranged in the area of the open end face of the holding container 5, protruding beyond the outside circumference of the cylindrical holding container 5. However, any other number of guide protrusions 37, 38 is also possible, whereby they cooperate with guide webs 39, 40 arranged on an inside surface of the cap 20 facing the holding container 5 and protruding beyond their surface in the direction of the longitudinal axis 15. The number and, for example, uniform angle-offset division of the guide webs 39, 40 over the circumference depend on the number of guide protrusions 37, 38 arranged on the holding container 5. These guide protrusions 37, 38 cooperate with the guide webs 39, 40 arranged on the inside of the cap jacket 23, so this makes it possible for the guide webs 39, 40 to run up onto the guide protrusions 37, 38 when the cap 20 is pushed in the direction of the longitudinal axis 15 of the holding container 5 into the open end face of same and with a corresponding clockwise turn, and to insert the sealing device 21 with its sealing face 33 into the interior space 10 of the holding container 5 due to the combined rotational and longitudinal movement owing to the guidance of the guide webs 39, 40 along the guide protrusions 37, 38. Instead of the guide protrusions 37, 38 and guide webs 39, 40, however, cooperating sections of thread would also be possible, likewise permitting the cap 20 and/or the entire closing device 9 to be simply screwed on and off.

In addition, the separation device 11 which is prepositioned in the interior space 10 of the holding container 5 is also shown here; in this exemplary embodiment it comprises at least one carrying body 41 and at least one separating element 42. A surface facing the holding container 5 optionally has a sealing device 43 protruding above it. This sealing device 43 may be formed, for example, by one or more sealing lips. It is advantageous if the material for the carrying body 41 is designed to have elastic memory and is formed by, for example, rubber, silicone rubber, pharmaceutical-grade rubber, bromobutyl rubber, a gel or an elastomeric plastic. Regardless of that, however, a plastic that can be fluid-tight, in particular watertight and optionally airtight and is selected from the following group may be used: polyethylene terephthalate (PET), polypropylene (PP), polyethylene (PE), polystyrene (PS), high-density polyethylene (HDPE), acrylonitrile-butadiene-styrene copolymer (ABS), thermoplastic elastomer (TPE), thermoplastic polyurethane (TPU), ultra-high-molecular-weight polyethylene having a very high molecular weight (PE-UHMW) (UHMWPE), polycarbonate (PC), polyamide (PA) [nylon], polyoxymethylene (POM) or other thermoplastics and/or a combination thereof. At the same time, however, a wide variety of different additives may also be added to the material to precisely coordinate the preselectable specific gravity.

The separation element 42 of the separation device 11 has end faces 44, 45 spaced a distance apart from one another in the direction of the longitudinal axis 15, whereby here the first end face 44 is facing the open end of the holding container 5. In addition, the figures also show in the area of the separation element 42, in diagrams that have been simplified schematically, the fact that several channels 46 are arranged in this separation element, the channels extending between the two end faces 44, 45.

As already described above, the separation device 11 has been introduced into a predetermined position in relation to the holding container 5 already in the starting position of the holding device 1 even before the interior space 10 has been filled. This predetermined position and/or location when the holding device 1 is used as a blood test tube is selected so that the heavier, i.e., cellular components find enough space in terms of volumes in the section of the interior space 10 which is designed between the separating device 11 and the end 7 that is closed by the end wall 8. In the case of whole blood, the cellular components form an amount in the range between 40% and 50% by volume, usually 45%. Due to the insertion into the predetermined position, which has already been performed prior to filling, the separation device 11 subdivides the interior space 10 into partial spaces 47, 48 arranged on both sides of the separation device. With all the exemplary embodiments described here, the partial space 47 is always arranged between the open end 6 and the separation device 11 and the other partial space 8 is arranged between the separation device 11 and the other closed end 7. Thus a holding volume of the partial space 48 formed between the separation device and the other end 7 of the holding container 5 is selected so that it is at least equal to or preferably slightly larger than the holding volume of the heavy components, i.e., the cellular components of the substance.

As already described in the introduction, the so-called starting position is to be understood in such a way that the separation device 11 is inserted into the holding container 5 prior to the closing of the holding container 5 by the closing device 9 and in this position it is held in the stationary manner with respect to the holding container 5 in the preselectable distance 12 starting from the open end 6 and/or its end face. This stationary mounting prevents further movement of the separation device 11 in the direction of the longitudinal axis 15 in the direction of the other end 7 which is closed here. After insertion of the separation device 11 and before closing the holding container 5 with the closing device 9, preferably the entire interior space 10 is reduced to a low pressure with regard to the external ambient pressure is reduced, i.e., evacuated. Therefore the holding device 1 can be used for the blood sampling which is to be performed in the known way.

The channels 46 which are arranged in this separating element 42 and are shown on a simplified scale here are designed so that they permit passage of the components of the substance to be separated exclusively while applying a compressive force to the substance in a working position as designated here. The application of compressive force may take place either by generating an excess pressure directly on the column of fluid or by generating a vacuum in the area on the side facing away from the separation device 11. These compressive forces which are built up to different extents thus constitute a pressure difference with regard to the partial spaces 47, 48 formed on both sides of the separation device 11. For example, if blood is introduced in a known way into the first partial space 47 between the separation device 11 and the closing device 9, then the vacuum prevailing in this partial space 47 is dissipated in relation to ambient pressure and optionally also the other partial space 48. If the pressure cannot be equalized rapidly and directly between the partial spaces 47, 48, formed on both sides of the separation device 11, then the prevailing difference may already result in a partial amount of the substance passing through the separation element 42 and/or its channels 46. Likewise, however, it is also possible for this compressive force to be applied by a centrifugation operation to be performed in the known way in which the force is applied starting from the open end 6 in the direction of the closed end 7 and thus in the direction of the separation device 11. Over the period of time when the compressive force is applied, the separation element 42, in particular its channels 46, are in a so-called working position in which the passage of the components of the substance to be separated is possible. After successful separation of the substances into their components and after removing the compressive force, the channels 46 suppress further passage of the components to be separated. Then this operating state of the holding device 1, in particular the separation element 42, is referred to as the separation position. In this separation position, the channels are able to suppress passage in both directions.

The individual channel(s) 46 may each have a flow cross section that corresponds in its dimension at least to the largest size of the components to be separated during the period of action of the compressive force, in particular during the separation process. This ensures that over this period of time the cellular components can also pass through the separation element 42, in particular its channels 46. To suppress the passage of components of the substance during the filling operation and before the start of the filling operation, the channels 46 of the separation element 42 are designed so that they prevent, i.e., suppress passage of the components to be separated when in the starting position.

For example, if an elastically deformable material is used for the separation element 42, it is advantageous if the channels 46 are closed in the separation. However, it would also be possible for the channels 46 to be designed to be automatically openable during the period of time when the compressive force is being applied so that the channels 46 can close again automatically after the compressive force is removed. The channels 46 preferably have an inside dimension with a lower limit of 10 μm, preferably 15 μm, in particular 20 μm and an upper limit of 25 μm, preferably 30 μm, in particular 50 μm. The inside dimension here is understood to refer to a passage opening where the values indicated are the dimensions in the direction perpendicular to the direction of flow.

To permit evacuation of the interior space 10 in the case of the prepositioned inserted position of the separation device 11, the channels 46 allow air to pass through at least in the starting position. However, this passage of air may also be possible during the working position and/or separation position. In the exemplary embodiment shown here, the separation element 42 is completely surrounded by the carrying body 41 at least in some areas, but preferably on its circumferential area that can face the holding container 5. The carrying body 41 here may be integrally molded on the separation element 42 by means of an injection molding operation, e.g., a two-component injection molding process. Therefore, a fixed and tight connection can again be achieved.

However, it would also be possible, as is described below, to meet the requirement exclusively with the arrangement of the separation element 42 to form the separation device 11 and to apply this directly to the inside surface 15 of the holding container 5.

To better seal the carrying body 41 with respect to the inside surface 19 of the holding container 5, it has the sealing device 43 already described briefly above. The sealing device 43 protrudes beyond the carrying body 41 on its circumferential area that can face the holding container 5 on the side facing away from the longitudinal axis 15 and is preferably formed by at least one sealing lip designed to be continuous.

It is also advantageous if the separation element 42 is connected in a fixed manner to the carrying body 41. Thus the separation element 42 can be joined to the carrying body 41 by a press fit, by gluing, welding, ultrasonic welding or laser welding. If the separation 42 is joined to the carrying body 41 by means of ultrasonic welding, it is advantageous to provide a so-called directional power generator on at least one of the parts to be joined together—the separation element 42 and/or the carrying body 41—in at least some areas. This directional power generator may be designed as a peripheral protrusion which is usually designed in the manner of a flange tapering to a point in the direction of the other components and to thus ensure an energy concentration for the connecting process.

It can also be seen from this diagram that the separation element 42 is aligned in a plane with the carrying body 41 in the area of its end face 44 which is facing the interior space 10 provided for filling—here the partial space 47—or even the carrying body 41 protrudes beyond it in the direction of the interior space 10 and/or partial space 47 provided for filling. This ensures that no dead spaces are created where cellular components could remain after a successful separation process in the partial space 47, between the separation device 11 and the closing device 9.

The separation element 42 may be formed from a wide variety of materials, in particular an elastic material, a ceramic material, a sintered or pressed material. For example, the material may be selected from the group consisting of polyolefins, e.g., polyethylene (PE) or polypropylene (PP), polyamide (PA), polystyrene (PS), polyether sulfanes, polyesters, thermoplastic elastomers (TPE, TPU), glass fibers, cellulose or compounds thereof, e.g., cellulose-mixed esters, cellulose acetates, celluloses nitrates or other natural fibers, e.g., cotton fibers or a combination thereof. In the case of ceramic materials, the channels 46 are formed by interconnected pores. In addition, the separation element 42 may also be referred to as a filter and/or a filter element.

However, the carrying body 41 may also be selected from the group of materials consisting of silicone rubber, pharmaceutical rubber, bromobutyl rubber, rubber, a gel or an elastomeric plastic, polyethylene terephthalate (PET), polypropylene (PP), polyethylene (PE), polystyrene (PS), polycarbonate (PC), thermoplastic elastomers (TPE, TPU), high density polyethylene (HDPE), acrylonitrile-butadiene-styrene copolymers (ABS), thermoset plastics, transparent polystyrene and/or a combination thereof.

In addition it is possible to provide the carrying body 41 and/or the separation element 42 with a coating in at least some areas. The coating used may be a chemical substance in particular selected from the group of silicones, silicone oil or produced by nanotechnology, in particular using nanoparticles. This coating may impede or completely prevent adhesion of the cellular components such as blood cells and may induce a hydrophobic and/or hydrophilic behavior. However, this coating may also be applied to at least individual channels 46 to thereby determine the blockage and/or flow-through behavior of the substance and/or components by influencing or varying the surface properties and/or surface tension.

The stationary mount of the separation device 11 in relation to the holding container 5, in particular between these components, can be accomplished by means of a press fit, a form-fitting stop, a catch connection, a bonded or welded joint, e.g., by ultrasonic or laser welding. The form-fitting stop on the holding container 5 may be formed, e.g., by protrusions 49 distributed over at least some areas of their circumference, so that the separation device 11, in particular the carrying body 41, is supported on these protrusion in the direction of the closed end 7. The protrusions 49 form the reference point for determining the distance 12 in the exemplary embodiment shown here.

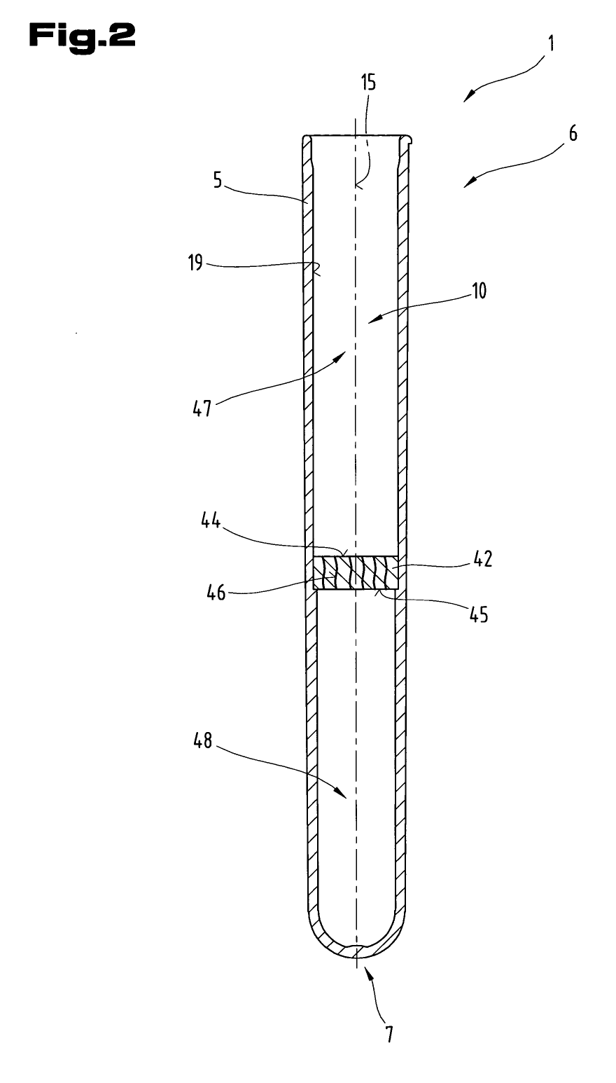

FIG. 2 shows another embodiment, optionally an independent embodiment, of the holding device 1, wherein for the sake of simplicity only the holding container 5 is shown without the closing device 9. In addition, the same component designations and/or reference numerals are used for the same components here as in the discussion of the previous FIG. 1. To avoid unnecessary repetition, reference is made her to the detailed description of FIG. 1.

In the exemplary embodiment shown here, the form-fitting stop is formed in or on the holding container 5 by a narrowing of the cross section of the interior space 10 which is designed in steps forward in the direction of the longitudinal axis 15. In addition this also shows that the surface 19 of the holding container 5 is designed in a cylindrical shape starting from the open end and continuing to the form-fitting stop, and thus has the same inside dimensions and/or the same inside cross section between the open end area 6 and the form-fitting stop over the longitudinal extent in the direction of the longitudinal axis 15.

The form-fitting stop which is designed here as a step, forms a difference in the cross section and/or diameter between the two partial spaces 47, 48. This difference in diameter may amount to between 0.5 mm and 1.5 mm, for example. In the area of the form-fitting stop, only the separation element 42 is shown to form the separation device 11 without the carrying body 41. For a better sealing effect in the outer edge area toward the inside surface 19 of the holding container 5, at least one sealing device which protrudes beyond the separation element 42 and is preferably designed to be continuous can be arranged on the separation element 42 on its circumferential area facing the holding container 5, as has already been described for the carrying body 41 and its sealing device 43. Again with this exclusive arrangement of the separation element 42, it is already inserted into the holding container 5 prior to filling the interior space 10 with the components to be separated and the separation element is held in this fixed position with regard to the holding container 5 at a preselectable distance 12, starting from the open end 6 of the holding container 5 which is provided for filling in the direction of the other end 7. Likewise, here again a fixed mounting with respect to the holding container 5 would be possible by means of a press fit, a form-fitting stop, a catch connection, a glued joint, a welded joint such as an ultrasonic or laser weld. However a constriction in the form of a bead or the like would also be possible in at least some areas. Due to the channels 46 arranged in the separation element 42, the mechanism of action described above in conjunction with FIG. 1 can be achieved.

The holding container 5 in this exemplary embodiment may also be designed to be cylindrical with respect to the longitudinal axis 5 in the area of its outside surface, but a conical taper between 0.1° and 3.0°, preferably between 0.6° and 0.8° may also be selected. However, this conical taper, as described above, may also be selected for the area of the inside surface 19 in the area of the partial space 47 and/or partial space 48.

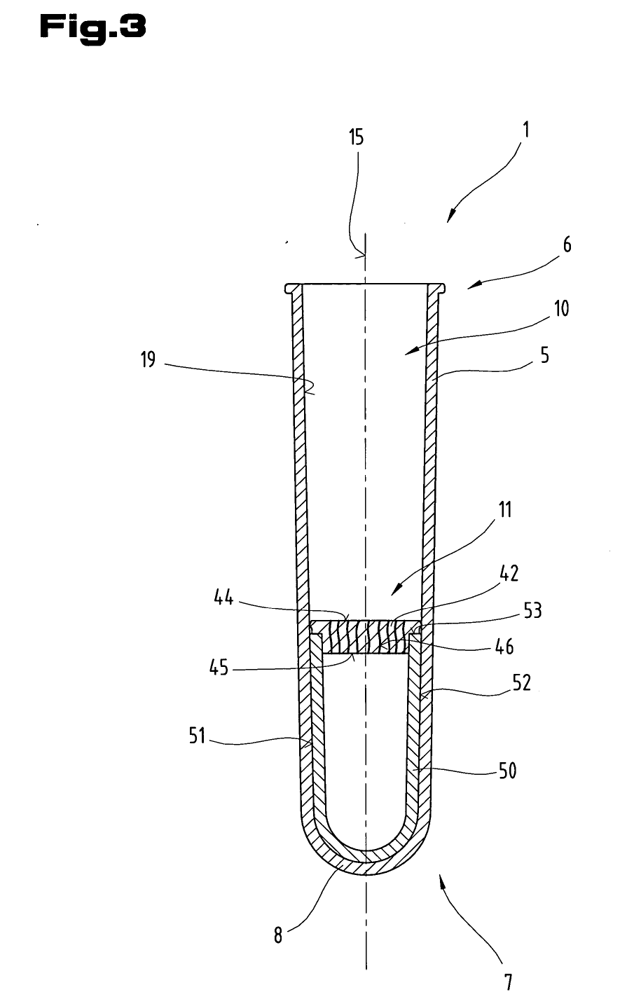

FIG. 3 illustrates another possible and possibly independent embodiment of the holding device 1 whereby in turn the same reference numerals and/or component notation is used for the same parts as in the preceding FIGS. 1 and 2. To avoid unnecessary repetition, reference is made to the detailed description in the discussion of the previous FIGS. 1 and 2.

For the sake of simplicity, here again only the holding container 5 is shown with its ends 6, 7 spaced a distance apart in the direction of the longitudinal axis 15 whereby the inside surface 19 may be designed with a conical taper to a slight extent from the open end 6 in the direction of the closed end 7. The form-fitting stop is formed here by an inside housing 50 that is inserted into the interior space 10 of the holding container 5 and which is also closed with its own end wall in the area facing the closed end 7 of the holding container 5. This inside housing 50 is inserted starting from the open end 6 to the closed end 7, whereby it is inserted and/or in contact with the inside surface 19 of the holding container 5 with virtually no play. It is also advantageous if the inside housing 50 is held so that it is stationary in relation to the holding container 5. Then the stationary mount between the inside housing 50 and the holding container 5 may be accomplished by means of a press fit, a glued joint, a welded joint such as an ultrasonic or laser weld. To be able to achieve close contact, an outside surface 51 of the inside housing 50 may be in contact with the inside surface 19 of the holding container 5 predominantly. This serves to minimize the clearance formed between the inside housing 50 and the holding container 5 as much as possible.

To facilitate the insertion movement of the inside housing 50 into the holding container 5, means to form at least one flow channel 52 may be provided between the outside surface 51 of the inside housing 50 and the inside surface 19 of the holding container 5. This flow channel 52 extends preferably starting from the closed end 7 over most of the entire longitudinal extent up to the end face of the inside housing. These means may be achieved for example through intentional minimal eccentricities and/or deviations from roundness in the area of the outside surface 51 and/or the inside surface 19. Likewise however, corresponding recesses and/or elevations may be provided in at least one of the two aforementioned surfaces namely the outside surface 51 and/or the inside surface 19. However, a surface structuring in the form of a plurality of elevations as well as recesses in the area of the inside surface 19 and/or the outside surface 51 would also be possible, likewise forming at least one cohesive flow channel 52 to thereby allow the amount of air contained between these two components to escape during the insertion movement of the inside housing 50 between the latter and holding container 5 and so as not to trap the air between them. This could result in impairment during storage or even unintentional loosening of the press fit when temperature fluctuations occur. Regardless of that, however, it would also be possible for the inside housing 50 to be in sealing contact with the inside surface 19 of the holding container 5 in the area of the open end face 53 of the inside housing. In addition however the facing surfaces namely the inside surface 19 and the outside surface 51 may be designed to be identical but opposite from one another. Therefore, an accurate contact with one another is achieved in the case of the conical taper as well as the cylindrical design and the clearance formed between the facing surfaces can be kept relatively small.

Regardless of that, it would also be possible to join the separation device 11 to the inside housing 50 in a fixed manner. If the separation device 11 is formed only by the separation element 42, as in the exemplary embodiment described here, then the fixed connection may also be established between these two components. If in addition a carrying body 41 is also used, it may be joined to the inside housing 50, thus permitting a joint insertion into the interior space 10.

If ultrasonic welding is provided for the fixed joining method, then a directional power generator may also be provided on at least one of the parts that are to be joined together—namely the holding container 5 and/or the carrying body 41 and/or the dividing element 42—at least in some areas—although it is not shown here. If the inside housing 5 is to be joined to the holding container 5 via an ultrasonic weld, a directional power generator may also be provided on at least one of these two components that are to be joined together. The same thing is also true of the connection between the inside housing 50 and the carrying body 41 and/or the separation element 42.

The inside housing 50 may be made of a plastic and/or glass, whereby the plastic may be selected only from the same group of materials as those described above for the holding container 5.

To achieve satisfactory investigation results and/or analytical results, at least partial surfaces of the inside surface 19 of the holding container 5 and/or of the inside container 50 may be provided with a coating (not shown here) to process and/or influence the whole blood introduced into the interior space 10 and/or the components of the substances that are to be separated for the analyses to be performed subsequently when using the holding device 1 as a blood test tube. This coating is formed by a chemical whereby the type and amount of the chemical are coordinated with the filling volume and the additional analysis. For example, the coating may be formed by lithium heparin or a coagulation activator. The coagulation activator may in turn contain microscopic particles of silica and may initiate coagulation of blood. In doing so, the fibrinogen is converted to fibrin, thereby yielding a serum sample. The lithium heparin counteracts the coagulation of blood. This is an anticoagulant additive which blocks the coagulation cascade by activating antithrombins and thus prevents coagulation of the blood sample. This yields a whole blood/plasma sample instead of blood cake and serum.

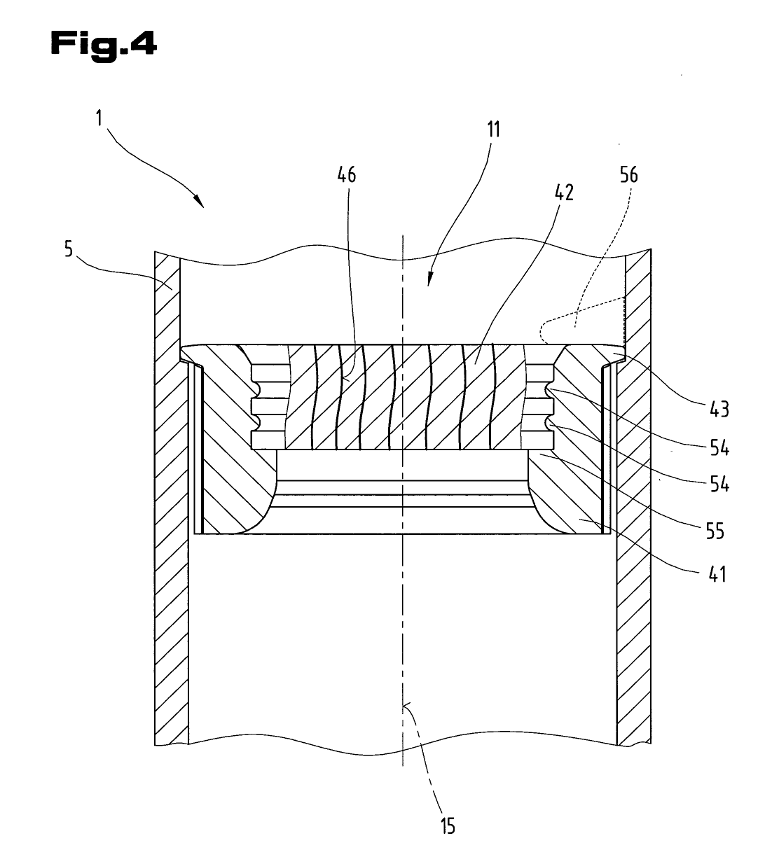

FIG. 4 shows a possible design which is optionally an independent design of the separation device 11 for a holding device 1, whereby the same component designations and/or reference numerals are again used for the same parts as in the preceding FIGS. 1 through 3. To avoid unnecessary repetition, reference is made to the detailed description in the preceding 1 through 3.

The separation device 11 shown here comprises the carrying body 40 and the separation element 42, which is shown only in the area of the longitudinal axis 15. For sealing the separation element 42 inserted into the carrying body 41 at the circumference, the carrying body 41 has at least one sealing protrusions 54, preferably several such sealing protrusions spaced a distance apart from one another in the direction of the longitudinal axis 15. On the side facing the closed end 7, a shoulder 55 protruding in the direction of the longitudinal axis 15 is arranged on the carrying body 41 for fixation of the relative position of the separation element 42. The separation element 42 is hindered thereby to prevent further movement in the direction of the closed end 7 as seen in the direction of the longitudinal axis 15.

To seal the separating device 11, the carrying body 41 has the sealing device 43 in the form of a peripheral sealing lip on the side facing the open end 6. This sealing lip is designed so that it additionally comes to a stop in the area of the inside surface 19 of the holding container 5 on the form-fitting stop, which is shown in the left area of FIG. 4. This achieves an axial fixation in the direction of the longitudinal axis 15 in relation to the holding container 5. In addition to the fixation of the position of the separation device 11 described previously with regard to the holding container 5, the same thing may also be accomplished in the direction of the longitudinal axis 15 as seen in the direction of the open end 15. This could be accomplished for example by a groove-shaped recess (not shown here) in the area of the inside surface 19, where the sealing device 43 is inserted to secure the position. However cooperation catch noses and catch recesses would also be conceivable accordingly.

In addition, however, it would also be possible for the separation element to be connected to the carrying body 41, in particular mounted there—as illustrated in the upper right portion of FIG. 4—via at least one snap hook 56 that is provided on the carrying body 41 and protrudes beyond the separation element 42 on the side facing away from the carrying body 41. Due to the additional surface formed so that it drops in the direction of the separation element 42, a type of baffle is achieved with which the components of the substance to be separated are guided and/or brought in the direction of the separation element 42 during the application of the compressive force, in particular the centrifugal force.

Regardless of that, however, the separation element 42 may also be inserted into a groove-shaped recess in the carrying body 41 (note shown in detail here). This achieves an axial fixation of position in both direction of movement.

The holding container 5 and/or the inside housing 50 may be made of a fluid-tight plastic, in particular a watertight and optionally airtight plastic. This plastic is selected from the group consisting of polyethylene terephthalate (PET), polyethylene (PE), polystyrene (PS), high-density polyethylene (HDPE), acrylonitrile-butadiene-styrene copolymers (ABS), thermoplastic elastomer (TPE), thermoplastic polyurethane (TPU), ultra-high-molecular-weight polyethylene (UHMW-PE), polycarbonate (PC), polyamide (PA), polyoxymethylene (POM), rubber, silicone rubber, pharmaceutical rubber, bromobutyl rubber, a gel and/or a combination thereof.

The direction of passage in all the embodiments described so far is always from bottom to top, i.e., from the open end 6 here to the closed end 7 of the holding container 5.

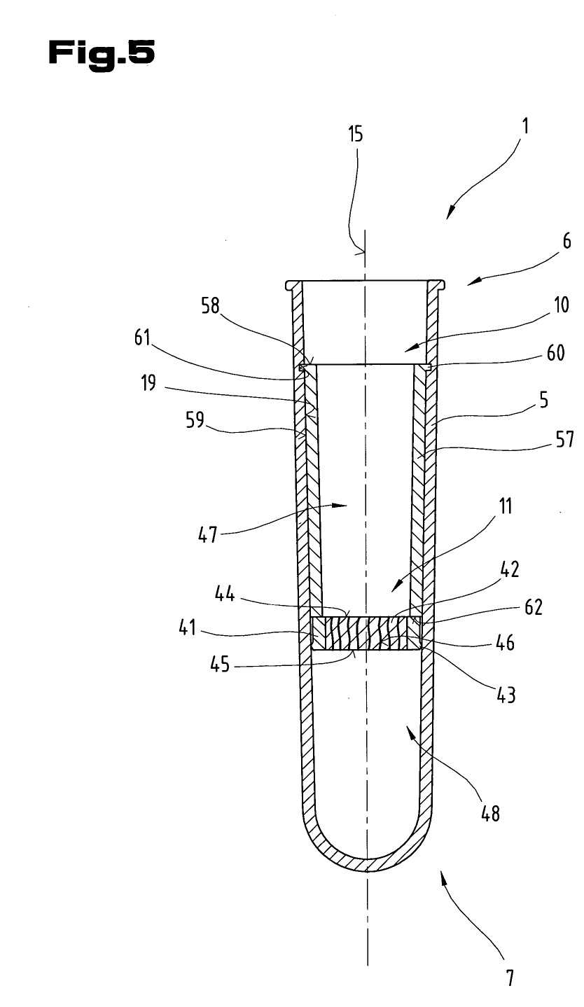

FIG. 5 show another possible embodiment of the holding device 1, which may optionally also be considered an independent embodiment, whereby the same reference numerals and/or component designations are again used for the same parts as in the preceding FIGS. 1 through 4. To avoid unnecessary repetition, please reference the detailed description in the previous FIGS. 1 through 4.

In the exemplary embodiment as shown here, only the holding container 5 with its ends 6, 7 spaced a distance apart in the direction of the longitudinal axis 15 whereby the inside surface 19 may be designed with a conical taper to a slight extent from the open end 6 in the direction of the closed end 7, as well as being designed to be cylinder and/or partially cylindrical. The stationary mounting of the separation device in relation to the holding container 5 is accomplished here by the fact that another interior housing 57 is inserted into the interior space 10 of the holding container 5, starting from the open end 6. This additional inside housing 57 is in turn in a fixed position in relation to the holding container 5. This may be accomplished, for example, by the fact that a catch element 60 protruding beyond the outside surface 59 engages in a catch recess 61 in the area of the inside surface 19 of the holding container 5 facing the open end 6 of the holding container 5 on an end face 58, thereby forming a catch connection. With a corresponding design of the catch element(s) 60 and/or the catch recess(es) 61, a connection that is tight on the circumference can be created between the additional inside housing 57 and the holding container.

The inside housing 57 shown here is designed to be approximately tubular, extending over a partial length of the holding container 5. On another end face 62 of the other inside housing 57 facing away from the end face 58, the separation device 11 is fixedly connected to the additional inside housing 57. This stationary connection may in turn be accomplished by the possibilities already described above. If a welding and/or gluing is selected, then a tight connection is created in this transitional area between the separation device 11 and the additional inside housing 57.

In the exemplary embodiment shown here, the separation device 11 in turn includes the carrying body 41 and the supporting element 42. The carrying body 41 here is connected to the end face 62 of the additional inside housing 57. Thus both the separation device 11 and the additional inside housing 57 are held and/or secured in a stationary mount in relation to the holding container 5.

It is advantageous here if the additional inside housing 57 is inserted into the holding container in a manner that is almost without play and/or if the outside surface 59 is in contact with most of the inside surface 19 of the holding containing 5.

To better seal the partial space 48 between the separation device 11 and the closed end 7 of the holding container 5, it is advantageous if the sealing device 43 is provided on the separation device 11, in particular the carrying body 41 and/or the separation element 42, in the area of the outside circumference. This prevents the substance and/or the components that form the substance from being able to enter into the interspace between the additional inside housing 57 and the holding container 5 and thereby lead to falsification of the analytical result(s).

In conclusion, it should be pointed out for the sake of order that for a better understanding of the design of the holding device, it and/or the components thereof have been to some extent drawn not to scale, i.e., enlarged and/or reduced in size.

The objects on which the actual inventive embodiments are based can be found in the description.

Especially the individual embodiments shown in FIGS. 1; 2; 3; 4; 5 form the subject matter of independent inventive embodiments. The inventive objects and embodiments in this regard can be derived from the detailed descriptions of these figures.

### LIST OF REFERENCE NUMBERS

1 Holding device
2 Mixture
3 Medium
4 Medium
5 Holding container
6 End
7 End
8 End wall
9 Closing device
10 Interior space
11 Separation device
12 Distance
13 Container wall
14 Dimension
15 Longitudinal axis
16 Plane
17 Plane
18 Dimension
19 Inside surface
20 Cap
21 Sealing device
22 Sealing stopper
23 Cap jacket
24 Coupling part
25 Coupling part
26 Coupling part
27 Coupling part
28 Coupling device
29 Protrusion
30 Protrusion
31 Holding ring
32 Shoulder
33 Sealing face
34 Sealing face
35 Recess
36 Opening
37 Guide protrusion
38 Guide protrusion
39 Guide web
40 Guide web
41 Carrying body
42 Separation element
43 Sealing device
44 End face
45 End face
46 Channel
47 Partial space
48 Partial space
49 Protrusion
50 Inside housing
51 Outside surface
52 Flow channel
53 End face
54 Sealing nose
55 Shoulder
56 Snap hook
57 Inside housing
58 End face
59 Outside surface
60 Catch element
61 Catch recess
62 End face

1. Separation device for insertion into an interior space of a holding container of a holding device for components of substances to be separated such as body fluids, tissue parts and/or tissue cultures, whereby the separation device comprises at least one separation element with end faces set a distance apart from one another in the direction of the longitudinal axis and there are multiple channels extending between the two end faces in the separation element, wherein the channels arranged in the separation element are designed so that in a working position they allow passage of the components of the substance to be separated exclusively while a compressive force is being applied to the substance, and in a separation position the channels suppress the passage of the components to be separated.

2. The separation device according to claim 1, wherein the channels each have a flow-through cross section during the period of time when the compressive force is being applied, in particular during the separation process, the dimension of said flow-through cross section corresponding at least to the largest size of the components to be separated.

3. The separation device according to claim 1, wherein when in the starting position, the channels of the separation element (42) suppress passage of the components to be separated.

4. The separation device according to claim 1, wherein the channels of the separation are closed in the separation position.

5. The separation device according to claim 1, wherein the channels are designed to be automatically openable during the period of time when the compressive force is acting.

6. The separation device according to claim 1, wherein the channels are designed to be automatically closing after removal of the compressive force.

7. The separation device according to claim 1, wherein the channels have an inside dimension with a lower limit of 10 μm, preferably 15 μm, in particular 20 μm and an upper limit of 25 μm, preferably 30 μm, in particular 50 μm.

8. The separation device according to claim 1, wherein the channels allow the passage of air at least in the starting position.

9. The separation device according to claim 1, wherein at least one sealing device that protrudes above the separation element and is preferably designed to be continuous is arranged on the separation element on its circumferential area that can face the holding container.

10. The separation device according to claim 1, wherein the separation element is surrounded by a carrying body in at least some areas.

11. The separation device according to claim 10, wherein the separation element is surrounded completely by the carrying body on its circumferential area that can face the holding container.

12. The separation device according to claim 1, wherein at least one sealing device that protrudes above the carrying body, in particular a sealing lip designed preferably to be continuous, is arranged on the carrying body on its circumferential area that can face the holding container.

13. The separation device according to claim 1, wherein the separation element is fixedly connected to the carrying body.

14. The separation device according to claim 13, wherein the separation element is connected to the carrying body with a press fit, a glued joint or a welded joint such as ultrasonic or laser welding.

15. The separation device according to claim 13, wherein the carrying body is integrally molded on the separation element.

16. The separation device according to claim 1, wherein a directional power generator for the ultrasonic welding is arranged in at least some areas on at least one of the parts (separation element and carrying body) that are to be joined together.

17. The separation device according to claim 1, wherein the separation element is connected to the carrying body over at least one snap hook that is arranged on a carrying body and protrudes above the separation element on the side facing away from the carrying body.

18. The separation device according to claim 1, wherein the separation element is inserted into a groove-like recess formed in the carrying body.

19. The separation device according to claim 1, wherein the separation element is arranged so that it is flat and planar in relation to the carrying body in the area which faces the interior space provided for filling or it protrudes above the carrying body in the direction of the interior space (10) provided for filling.

20. The separation device according to claim 1, wherein the separation element is made of an elastic material.

21. The separation device according to claim 20, wherein the material is selected from the group consisting of polyolefins, e.g., polyethylene (PE) or polypropylene (PP), polyamides (PA), polystyrene (PS), polyether sulfanes, polyesters, thermoplastic elastomers (TPE, TPU), glass fibers, cellulose or compounds thereof, such as mixed cellulose esters, cellulose acetates, celluloses nitrates or other natural fibers, e.g., cotton fibers or a combination thereof.

22. The separation device according to claim 1, wherein the separation element is formed by a ceramic material.

23. The separation device according to claim 1, wherein the carrying body is selected from the group of materials consisting of silicone rubber, pharmaceutical rubber, bromobutyl rubber, rubber, a gel or an elastomeric plastic, polyethylene terephthalate (PET), polypropylene (PP), polyethylene (PE), polystyrene (PS), polycarbonate (PC), thermoplastic elastomers (TPE, TPU), high-density polyethylene (HDPE), acrylonitrile-butadiene-styrene copolymers (ABS), thermoset plastics, transparent polystyrene and/or a combination thereof.

24. The separation device according to claim 1, wherein the carrying body is provided with a coating in at least some areas.

25. The separation device according to claim 1, wherein the separation element is provided with a coating in at least some areas.

26. The separation device according to claim 1, wherein the channel of the separation element are provided with a coating in at least some areas.

27. The separation device according to claim 24, wherein the coating is formed by a chemical substance, in particular from the group of silicones, silicone oil or by nanotechnology, in particular by nanoparticles.

28. The holding device for the components of substances to be separated such as body fluids, tissue parts and/or tissue cultures having a holding container that borders an interior space with an inside surface, and having two ends spaced a distance apart from one another in the direction of the longitudinal axis, at least one of which is formed with an opening, having at least one closing device that can be opened for the open end of the holding container and having one separation device that is inserted into the interior space, wherein the separation device is designed according to claim 1 and the separation device is inserted into the holding container prior to filling the interior space with the components to be separated and is held fixedly in this position with regard to the holding container at a preselectable distance starting from the open end of the holding container provided for filling in the direction of the other end and the separation device subdivides the interior space into two partial spaces arranged on both sides thereof

29. The holding device according to claim 28, wherein the distance is selected so that the holding volume of the partial space formed between the separation device and the additional end of the holding container is at least equal to or slightly greater than the holding volume of the heavy components of the substance.

30. The holding device according to claim 28, wherein the stationary mount is in the direction of the open end as seen in the direction of the longitudinal axis.

31. The holding device according to claim 28, wherein the stationary mount of the separation device with respect to the holding container is accomplished by means of a press fit, a form-fitting stop, a glued joint or a welded joint such as ultrasonic welding or laser welding.

32. The holding device according to claim 31, wherein the form-fitting stop on the holding container is formed by protrusions distributed over at least some areas of the circumference.

33. The holding device according to claim 31, wherein the form-fitting stop on the holding container is formed by a narrowing of the cross section of the interior space.

34. The holding device according to claim 31, wherein the form-fitting stop is formed by an interior housing inserted into the interior space of the holding container in the area facing away from the open end of the holding container.

35. The holding device according to claim 28, wherein the stationary mount of the holding device with regard to the holding container is accomplished via another interior housing extending from the open end in the direction of the other end and the separation device is connected in the area of an end face which faces the other end.

36. The holding device according to claim 34, wherein the inside housing is inserted into the holding container with virtually no play.

37. The holding device according to claim 34, wherein the inside housing is held in a stationary mount in the holding container.

38. The holding device according to claim 37, wherein the stationary mount between the inside housing and the holding container is accomplished via a press fit, a catch connection, a glued connection or a welded joint such as ultrasonic or laser welding.

39. The holding device according to claim 34, wherein an outside surface of the inside housing is in contact with the inside surface of the holding container over most of the surface.

40. The holding device according to claim 34, wherein means for forming at least one flow channel are provided between the outside surface of the inside housing and the inside surface of the holding container.

41. The holding device according to claim 34, wherein the inside housing is in sealing contact with the inside surface of the holding container in the area of its open end face.

42. The holding device according to claim 34, wherein the facing surfaces of the inside housing and the holding container are designed to be identical and opposite one another.

43. The holding device according to claim 28, wherein the separation device is fixedly connected to the inside housing.

44. The holding device according to any one of claim 28, wherein a directional power generator for the ultrasonic welding is arranged on at least one of the parts to be joined together (holding container, carrying body, separation element) in at least some areas.

45. The holding device according to claim 28, wherein a directional power generator for the ultrasonic welding is arranged on at least one of the parts to be joined together (holding container, inside housing) in at least some areas.

46. The holding device according to claim 28, wherein a directional power generator for the ultrasonic welding is arranged on at least one of the parts to be joined together (inside housing, carrying body, separation element) in at least some areas.

47. The holding device according to claim 28, wherein the holding container and/or the inside housing is/are made of a plastic.

48. The holding device according to claim 47, wherein the plastic is selected from the group consisting of polyethylene terephthalate (PET), polypropylene (PP), polyethylene (PE), polystyrene (PS), high-density polyethylene (HDPE), acrylonitrile-butadiene-styrene copolymers (ABS), thermoplastic elastomers (TPE), thermoplastic polyurethane (TPU), ultra-high-molecular-weight polyethylene (UHMW-PE), polycarbonate (PC), polyamide (PA), polyoxymethylene (POM).

49. The holding device according to claim 28, wherein the holding container and/or the inside housing is/are made of glass.

50. The holding device according to claim 28, wherein the interior space of the holding container is lowered evacuated to a pressure lower than ambient pressure.

51. The holding device according to claim 28, wherein at least partial areas of the inside surface of the holding container and/or the inside container are provided with a coating.

52. A method for separating components of substances to be separated such as body fluids, tissue parts and/or tissue cultures, in which a separation device having a separation element is inserted into an interior space of a holding container of a holding device and is brought to a preselectable distance starting from the open end of the holding container intended for filling and is held in this position fixedly in relation to the holding container so that partial spaces for the components to be separated on formed on both sides of the separation device at a distance from one another, then the holding container is closed and next the substance is introduced into at least the partial space between the separation device and the open end of the holding container provided for filling and next the substance thereby introduced is acted upon by a compressive force, in particular a centrifugal force, acting on this substance in the direction of the separation device, whereby when a predetermined minimum force is exceeded, the components of the substance to be separated are moved through the channels of the separation element and at the same time while the centrifugal force is acting, the substance is divided into the components to be separated and thereby at least the heavy components are brought into the partial space between the separation device and the other end of the holding container and after the centrifugal force has been removed in the separation position of the separation device, the passage through the channels in the separation element is suppressed for the substances to be separated.

53. The method according to claim 52, wherein before closing the holding container, the entire interior space is evacuated to a lower pressure than ambient pressure.

54. The method according to claim 52, wherein the passage of the components of the substance through the channels of the separation element is suppressed in both directions of passage in the separation position.

55. The method according to claim 52, wherein the passage of the substance through the channels of the separation element is suppressed in the separation position.

56. The method according to claim 52, wherein the channels are opened automatically during the period of lime when the compressive force is acting.

57. The method according to claim 52, wherein the channels are closed automatically after the compressive force is removed.

58. The method according to claim 52, wherein at least partial areas of the inside surface of the holding container and/or of the inside container are provided with a coating.
